(19) United States
(12) Patent Application Publication
(10) Pub. No.: US 2022/0053735 A1
(43) Pub. Date: Feb. 24, 2022

(54) LEASH HANDLE WITH INTEGRATED STORAGE AND WASTE BAG DISPENSATION

(71) Applicant: Matthew Hoag Wenz, San Diego, CA (US)

(72) Inventor: Matthew Hoag Wenz, San Diego, CA (US)

(21) Appl. No.: 16/997,600

(22) Filed: Aug. 19, 2020

(51) Int. Cl. A01K 27/00; E01H 1/12

(52) U.S. Cl. CPC A01K 27/003; E01H 2001/1273; E01H 2001/128; E01H 1/12

(57) ABSTRACT

A handle for a pet leash includes: a cylindrical core; a first cylindrical storage cavity housed within the cylindrical core; and a lead line attachment feature. A handle for a pet leash includes: a first storage cavity; a second storage cavity; and a lead line attachment feature. A leash comprising: a handle comprising: a first storage cavity; and a second storage cavity; a lead line coupled to the handle; and an attachment feature coupled to the lead line.

### BACKGROUND

Many pet owners use bags for collecting and disposing of pet waste. There exists a need for a way to conveniently carry such bags for use.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates a top plan view of a leash handle with integrated storage and bag dispensation according to an exemplary embodiment;

FIG. 2 illustrates a sectional view of the leash handle of FIG. 1;

FIG. 3 illustrates an exploded view of the leash handle of FIG. 1;

FIG. 4 illustrates an exploded view of the leash handle of FIG. 1 including a waste bag roll and item for storage;

FIG. 5 illustrates a partially exploded view of the leash handle of FIG. 1 including a waste bag roll and stored item;

FIG. 6 illustrates an exploded perspective view of an alternative leash handle according to an exemplary embodiment;

FIG. 7 illustrates a top plan view of a body of the leash handle of FIG. 6;

FIG. 8 illustrates a left side elevation view of the body of the leash handle of FIG. 6;

FIG. 9 illustrates a right side elevation view of the body of the leash handle of FIG. 6; and

FIG. 10 illustrates an exploded view of the leash handle of FIG. 6.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a pet leash handle that provides storage for waste bags and/or other small items,

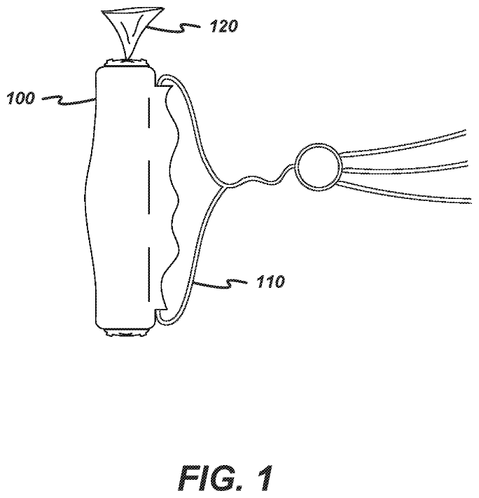

FIG. 1 illustrates a top plan view of a leash handle 100 with integrated storage and bag dispensation according to an exemplary embodiment. In this example, the leash handle 100 is attached to a lead line 110 as used in a leash assembly including handle 100. The lead line 110 may be further coupled to a collar attachment feature, a harness attachment feature, and/or other appropriate features for attaching the lead line 110 to a pet restraint, in some embodiments, the lead line 110 may serve as a collar or harness (e.g., the lead line may include a fixed loop at one end such that a variable-sized collar may be provided by feeding a portion of the lead line 110 through the fixed loop).

In addition, the leash handle 100 in this example stores and dispenses pet waste bags 120. The leash handle 100 main body may include a generally cylindrical portion that may include various outer surface features, as shown. Such outer surface features, such as curved planes, ridges, etc., may^{,} provide improved grip security or comfort for a user. This example includes a palm engagement element having a parabolic surface shape that is complementary to a human palm shape. This example handle 100 further includes a finger engagement element having a multi-finger grip area with multiple ridges and valleys that provides a complementary shape to the fingers of a user when placed in a fist shape as when holding handle 100. Different embodiments may include handle bodies with various different shapes or features, as appropriate.

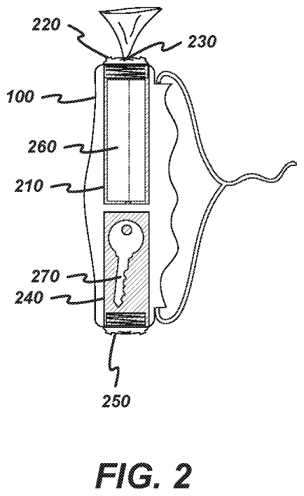

FIG. 2 illustrates a sectional view of the leash handle 100. In this example, the leash handle 100 includes a first storage cavity 210, a first cap 220 with dispensation aperture 230, a second storage cavity 240, a second cap 250, a roll of waste bags 260, and a house key 270.

Different embodiments of leash handle 100 may include various different specific features. For instance, some embodiments may include a single storage cavity, As another example, the storage cavities may be sized differently than shown.

The storage cavities 210 and 240 may be used to store various elements, such as pet waste bags 120, personal items such as keys 270, pet treats such as training treats, identification, pet or owner medication, and/or other such items.

In this example, the storage cavities 210 and 240 are cylindrical and the main body portion or “core” of the handle 100 may have a cylindrical shape that includes the two storage cavities. The first storage cavity 210 and second storage cavity 240 may be aligned along a center axis of a cylindrical core of leash handle 100, as shown.

Different embodiments may have differently shaped cavities and/or differently arranged cavities, as appropriate for various handle shapes. For instance, some embodiments may include two storage cavities similar to storage cavity 210, each including a post 310, such that multiple rolls of waste bags may be stored and/or dispensed at the same time. As another example, some embodiments may include various dedicated or specialized storage features. For instance, some embodiments may include key rings, clips, or other appropriate attachment features for items such as house keys. As another example, some embodiments may include a cavity with multiple slots or compartments, such as a cavity having an area suitable for storing identification, cash, and/or keys and a separate area suitable for storing treats. As another example, cavities may have other shapes than cylinders with a circular cross-section, such as cavities having cross-section shapes such as octagonal, rectangular, triangular, elliptical, etc.

End caps 220 and/or 250 may be selectively coupled to or “secured” to the openings in the ends (or “open ends”) of the handle body 100 in various ways. For instance, end caps 220 and 250 may be screw-in caps that include a threaded portion that engages a complementary threaded portion of the associated storage cavity. As another example, some embodiments may include caps with a flexible or semi-flexible portion (e.g., a plastic, rubber, or silicone portion) that is able to be securely inserted into the cavity. As another example, the cap may have a lip or slot that engages a. complementary slot or lip of the associated storage cavity. In some embodiments, the end caps 220 and/or 250 may have a rigid inner body or skeleton (e.g., a plastic or metal frame) that includes at least a portion covered in a flexible wrap or outer surface (e.g., a portion of the frame may be covered in rubber or silicone). As another example, the end caps 220 and/or 250 may be associated with an O-ring or gasket that engages indentions in the end caps and/or inner surface of the storage cavities 210 and/or 240, respectively.

In some embodiments, end caps 220 and/or 250 may be associated with various attachment and/or storage features. For instance, end cap 250 may be coupled to a clip or key ring. In addition, end caps 220 and/or 250 may be coupled to the main body of handle 100 in various ways. For instance, each end cap 220 or 250 may be coupled to a line or tether that is further coupled to the main body of handle 100 in order to prevent loss of end caps 220 and/or 250.

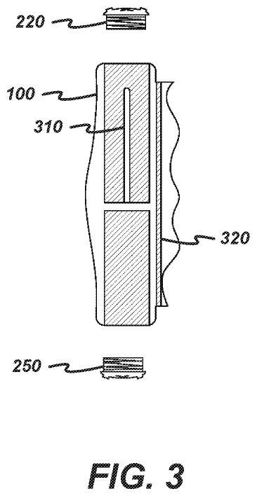

FIG. 3 illustrates an exploded view of the leash handle 100. In this view, a post 310 and lead line cavity 320 are visible. Post 310 may extend out from the center of the flat bottom wall or “circular end surface” of cylindrical cavity 210,

The post 310 may accept rolls of pet waste bags. Such bags may be provided in sets of multiple units (e.g., ten bags) wrapped around a cylindrical core. The cylindrical core may include a physical element such as a cardboard or plastic tube or the cylindrical core may be a void in an arrangement of bags. Post 310 may be sized to fit within a center cavity of the cylindrical core such that the core is able to rotate about the post 310 as each bag is dispensed.

Lead line cavity 320 in this example is a cylindrical hole that runs along a portion of the handle 100. In addition to, or in place of, the lead line cavity 0320, different embodiments of leash handle 100 may include various different lead line attachment features. Such lead line attachment features may include through-holes, clips, buttons, loops, tabs or other protrusions, slots or other receptacles, and/or various other appropriate elements that may be used to attached various types of lead lines.

Furthermore, different embodiments may include a differently shaped or otherwise differently arranged lead line cavity 320 than shown. For instance, a flat “ribbon” style leash may be associated with a handle 100 that includes a lead line cavity 320 having a generally rectangular cross-sectional shape. As another example, lead line cavity 320 may not extend through the handle 100 as shown, and may instead include a pair of cavities that each accept and secure an end of a “Y” shaped lead line end. In some embodiments, lead line 110 may be integrated into handle 100, where the lead line cavity 320 may be defined by the dimensions of the lead line 110 (e.g., handle 100 may be injection-molded around the lead line or otherwise integrated with the lead line).

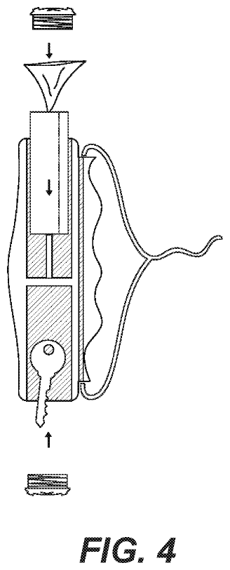

FIG. 4 illustrates an exploded view of the leash handle 100 including a roll of waste bags and item for storage. FIG. 5 illustrates a partially exploded view of the leash handle 100 including a waste bag roll and stored item, where a portion of a waste bag is extended through dispensation opening or aperture 230. The dispensation aperture 230 may be, or may include, a through-hole, one or more slots or slits, a cross-shaped or star-shaped opening, combinations or such elements, and/or other appropriate apertures or openings.

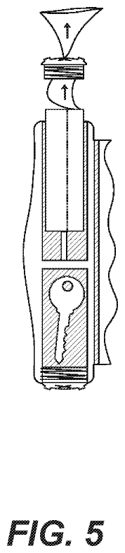

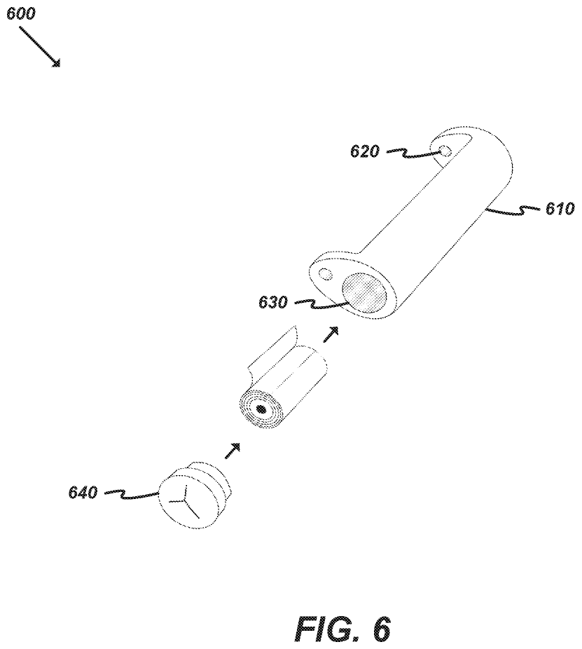

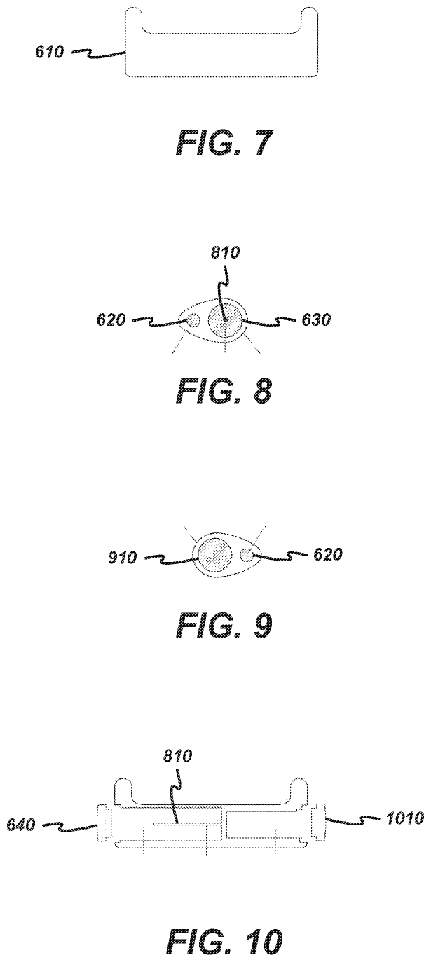

FIG. 6 illustrates an exploded perspective view of an alternative leash handle 600, 7 illustrates a top plan view of a body of the alternative leash handle 600. FIG. 8 illustrates a left side elevation view of the body 610 of the alternative leash handle 600. FIG. 9 illustrates a tight side elevation view of the body 610 of the alternative leash handle 600. FIG. 10 illustrates an exploded view of the alternative leash handle 600.

The alternative leash handle 600 may include a main body 610 with a smooth cylindrical outer shape with two protrusions that each include a through-hole 620 to accommodate a lead line, a first storage cavity 630, a first end cap 640, a post 810, a second storage cavity 910, and a second end cap 1010.

The through-holes 620 in this example are aligned along an axis that passes through the center of each through-hole 620. Each of the through-holes 620 may be able to accept a portion of a lead line which may have a “Y” junction at one end, where each arm of the Y passes through a through-hole 620 and may be secured using a knot or other appropriate coupling feature. Different embodiments may include various other features for coupling a lead line to the handle 600 or 100. For instance, a rigid rod or dowel may be inserted between through-holes 620 and a clip or lead line attached thereto.

In this example, the end caps are compression-fit and do not include threaded portions. Such end caps may be made of flexible material such as rubber or silicone and may be able to engage the interior wall of the associated storage cavity such that the end cap and any items stored with the cavity are retained in the cavity.

Leash handles 100, 600, and/or other such handles may be made from various appropriate materials, or combinations of materials. The handles may include a rigid or semi-rigid core that may be made from materials such as metal, plastic, etc. In addition, the handles may include an outer layer or wrap made from a somewhat pliable material such as rubber, silicone, etc. In some embodiments, the core and outer layer may be combined into a single element that may be made from rigid and/or pliable materials including metal, plastic, rubber, silicone, etc. End caps such as caps 220, 250, 640, and/or 1010 may be made from rigid and/or pliable materials such as metal, plastic, rubber, silicone, etc. Some embodiments may include clips, rings, washers, or other lead attachment elements made from metal or plastic.

No element used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

I claim:

1. A handle for a pet leash, the handle comprising:
a cylindrical core;
a first cylindrical storage cavity housed within the cylindrical core; and
a lead line attachment feature.

2. The handle of claim 1, wherein the first cylindrical storage cavity comprises a post extending from a center of an end surface of the first cylindrical storage cavity.

3. The handle of claim 1 further comprising a first end cap that secures an open end of the first cylindrical storage cavity.

4. The handle of claim 3, wherein the first end cap comprises an opening that allows waste bags to feed through if the open end of the first cylindrical storage cavity is secured.

5. The handle of claim 1, wherein the lead line attachment feature comprises a cylindrical cavity or a pair of through-holes aligned along an axis.

6. The handle of claim 1 further comprising a second cylindrical storage cavity housed within the cylindrical core.

7. The handle of claim 6 further comprising a second end cap that secures an open end of the second cylindrical storage cavity.

8. A handle for a pet leash, the handle comprising:
a first storage cavity;
a second storage cavity; and
a lead line attachment feature.

9. The handle of claim 8, wherein the lead line attachment feature comprises a cylindrical cavity or a pair of through-holes aligned along an axis.

10. The handle of claim 8 further comprising a first cap associated with the first storage cavity and a second cap associated with the second storage cavity.

11. The handle of claim 10, wherein the first cap comprises an opening that allows waste bags to be fed through the first cap.

12. The handle of claim 10, wherein the first cap comprises a threaded portion.

13. The handle of claim 10, wherein a portion of the first cap forms a compression fit with an opening of the first storage cavity.

14. The handle of claim 8, wherein the first storage cavity comprises a post that secures a roll of waste bags while allowing the roll of waste bags to rotate about the post within the first storage cavity.

15. A leash comprising:
a handle comprising;
a first storage cavity; and
a second storage cavity;
a lead line coupled to the handle; and
an attachment feature coupled to the lead line.

16. The leash of claim 15 further comprising a first cap associated with the first storage cavity and a second cap associated with the second storage cavity.

17. The leash of claim 6, wherein the first cap comprises an opening.

18. The leash of claim 15, wherein the handle comprises contoured palm and finger engagement elements.

19. The leash of claim 15, wherein the handle comprises at least one of metal, plastic, silicone, or rubber.

20. The leash of claim 15, wherein the handle comprises a cylindrical core and the first storage cavity and the second storage cavity are arranged along a center axis of the cylindrical core.
